(19) United States
(12) Patent Application Publication
(10) Pub. No.: US 2017/0109805 A1
(43) Pub. Date: Apr. 20, 2017

(54) System and Method for Arranging Services

(71) Applicant: Maramoja Transport Ltd, Nairobi (KE)

(72) Inventor: Jason Eisen, Nairobi (KE)

(21) Appl. No.: 15/361,232

(22) Filed: Nov. 25, 2016

Related U.S. Application Data
(63) Continuation of application No. PCT/KE2015/000045, filed on May 26, 2015.

(30) Foreign Application Priority Data
May 26, 2014 (KE) KE/P/2014/002077

(51) Int. Cl. G06Q 30/06

(52) U.S. Cl. CPC G06Q 30/0629; G06F 17/3053

(57) ABSTRACT

The invention relates to provision of services and methods and systems for efficient provision thereof. In an aspect, the invention is suitable for providing improved hire of transportation services by a user, or other services as described herein. The user makes a request for transportation service, a server prepares a ranked list of preferred service providers, and the server returns the ranked list to the user. Preparation of the ranked list of preferred service providers involves identification of providers associated with a network of users and other providers, and using a combination factor to rank the providers.

### CROSS-REFERENCE TO RELATED APPLICATIONS

This application claims priority to Kenya Provisional Application Ser. No. KE/P/2014/002077, filed May 26, 2014, and PCT application number PCT/KE2015/000045, filed May 26, 2015, the contents of which are incorporated herein by reference in their entirety.

### BACKGROUND

Transportation is fundamental to modern lifestyles throughout the world. The size and population of modern cities often makes the identification of reliable transportation, whether such transportation is of people or goods, a difficult and unreliable task.

Practical methods used for hiring taxis and couriers changed little throughout the 20th century, and remain un-optimized given the advent of technology. Current methods rely on the hirer having knowledge of available options. Due to the lack of interlinks among users and providers, this necessarily results in a hirer having limited (and, therefore, frequently non-ideal) options. Having limited options means that a user is often forced to settle for a provider that is unsafe, untimely, too expensive, or a combination thereof.

There remains a need for a system that aids a person or company wishing to hire a suitable provider for transportation of goods or people.

### TECHNICAL FIELD OF THE INVENTION

The technical field of the invention relates to methods and systems for efficient provision of services to users.

### SUMMARY

In an aspect is a method comprising: receiving, by a server over a network, a request from a requesting user, the request comprising a requested service and an identification of the requesting user; in response to the request, determining a ranked list of preferred service providers by: (a) accessing, on the server, data for a first preferred service provider associated with the requesting user, wherein the data comprises identification data and location data; (b) accessing, on the server, data for a second preferred service provider associated with a friend user, wherein the friend user is associated with the requesting user on a social network and wherein the data comprises identification data and location data; (c) assigning, using a combination factor, a ranking to the first preferred service provider and a ranking to the second preferred service provider, and creating the ranked list of preferred service providers from the assigned rankings; and transmitting data from the ranked list of preferred service providers to the requesting user via the network. In embodiments:

the ranked list of preferred service providers comprises a plurality of preferred service providers associated with the requesting user, and a plurality of preferred service providers associated with the friend user;

the combination factor includes one or more factors selected from: instantaneous preferred service provider proximity to the requesting user; social relation of the preferred service provider to the requesting user; historical performance of the preferred service provider; preference level of the requesting user; and preference level of the friend user;

the ranked list of preferred service providers comprises a plurality of preferred service providers associated with the requesting user, and a plurality of preferred service providers associated with the friend user; and wherein the combination factor includes one or more factors selected from: instantaneous preferred service provider proximity to the requesting user; social relation of the preferred service provider to the requesting user; historical performance of the preferred service provider; preference level of the requesting user; and preference level of the friend user;

the data accessed for the first preferred service provider further includes data selected from performance data; relational data; and preference level of the requesting user; and the data accessed for the second preferred service provider further includes data selected from performance data; relational data; and preference level of the friend user;

the request further comprises an origin location and a destination location, and wherein the request is for a transportation service;

the request is received via SMS, USSD, a data network, or peer-to-peer mesh networking;

the identification data comprises information selected from: a name; a contact phone number; and a unique identifier number;

the ranked list of preferred service providers comprises a plurality of preferred service providers associated with the requesting user, and a plurality of preferred service providers associated with the friend user; and the ranked list of preferred service providers further comprises a service providers from a global list of service providers;

the transmitted data is received by the requesting user, and wherein the method further comprises receiving, by the server over the network, a selection from the requesting user;

the method further comprises retrieving, from the server, identification data and location data for a third preferred service provider, wherein the third preferred service provider is associated with the first preferred service provider;

the method further comprises determining a follower user associated with the requesting user on a social network, and retrieving from the server identification data and location data for a fourth preferred service provider, wherein the fourth preferred service provider is associated with the follower user;

the method further comprises transmitting, by the server: a service request to the first preferred service provider; and a service request to the second preferred service provider;

the method further comprises: transmitting, by the server, a service request to the first preferred service provider, and a service request to the second preferred service provider; and receiving, by the server, a response from the first preferred service provider, the response selected from an acceptance of the service request or a rejection of the service request;

the method further comprises receiving, by the server, a selection from the requesting user, wherein the selection identifies one preferred service provider in the ranked list of preferred service providers;

the method further comprises: transmitting, by the server, a service request to the first preferred service provider, and a service request to the second preferred service provider; receiving, by the server, a response from the first preferred service provider, the response selected from an acceptance of the service request or a rejection of the service request; and receiving, by the server, a selection from the requesting user, wherein the selection identifies one preferred service provider in the ranked list of preferred service providers; and

the method further comprises: receiving, by the server, a selection from the requesting user, wherein the selection identifies one preferred service provider in the ranked list of preferred service providers; and transmitting, by the server, an acceptance to the identified preferred service provider.

In an aspect also is provided devices configured to carry out the methods described herein.

In an aspect also is provided computer-readable media containing computer instructions for implementing the methods described herein.

These and other aspects will be apparent from the disclosure provided herein.

### BRIEF DESCRIPTION OF THE FIGURES

FIG. 1 provides a scheme showing the generation of a request by a user and processing of the request by a server, according to an embodiment herein.

FIG. 2 provides a scheme showing the transmission of selection and acceptance by the user and server, respectively, according to an embodiment herein.

FIG. 3 provides a scheme showing processing of a request by a server, according to an embodiment herein.

### DETAILED DESCRIPTION OF VARIOUS EMBODIMENTS

In embodiments, the invention is suitable for providing improved hire of services by a user. The term “user” as used herein refers to a mobile phone account holder registered with the system described herein, and is meant to include individuals as well as organizations such as companies, academic institutions, government offices, and the like. Throughout this disclosure, an individual (i.e., a natural person) may be used as a model user, although this is solely for ease of description and is not (unless indicated otherwise or clear from the context) intended to be so limiting—i.e., the same disclosure can apply to corporate users and other types of users.

As will be mentioned below, the type of service that can be hired using the system/methods of the invention include transportation services, professional services, personal services, and other services. Throughout the following specification, in order to help illustrate the invention, hiring of transportation services will be used as exemplary. Such use is not intended to limit the application and invention—the same disclosure also applies to non-transportation services such as those mentioned herein.

In embodiments, the user can request transportation services using the methods and systems described herein. By “transportation services” is meant to include transport of people (e.g., individual taxi service, shared ride service, or the like) as well as transport of goods (e.g., courier service, freight service, or the like). The term “taxi” is meant to include all types of vehicles for hire, such as passenger cars, motorcycles, auto rickshaws, limousines, four-wheel drive vehicles, mini-buses and the like, provided that such vehicle is not self-driven (i.e., the vehicle is provided with a driver). Throughout this disclosure, a passenger car taxi may be used as a model transportation service, although this is solely for ease of description and is not (unless indicated otherwise or clear from the context) intended to be so limiting—i.e., the same disclosure can be applied to other types of taxi services and other types of transportation services.

The requested transportation service involves a vehicle and a vehicle operator. The latter is referred to as a “service provider” (herein also “SP”) and may be a taxi driver, courier person, or the like, depending on the type of transportation service. Each SP is individually registered with the system and may be identified by a unique identifier tag such as a mobile phone number, email address, or a government-issued ID number, or a service provider Personal Identification Number (SPPIN) that is assigned by the system upon registration of the SP. The system may create a record within a database for the SP, with such record containing one or more fields selected from: company affiliation (for service providers that are employed by a company); performance history; current location; location history; user feedback; user rating; completion statistics (e.g., number of trips assigned and number of trips completed); associated service providers (i.e., other service providers who are identified by the SP as preferred, also referred to herein as “ASPs”); and the like. In embodiments, each SP is issued a mobile communication device (the “SP Device”) with an ability to determine the SP's instantaneous location. In other embodiments, the SP may use any mobile communication device with data capabilities and an ability to determine the SP's instantaneous location.

The methods and systems of the invention require initial registration of a user. In embodiments, such registration involves creating a record in a database, such as on a server. The record may contain a variety of fields, as described herein, and may be indexed via any unique identifier. In embodiments, the unique identifier used to index the database of records (referred to herein as the “record indexer”) is the user's mobile phone number, email address, or a government-issued ID number, or is a Personal Identification Number (PIN) that is assigned by the system upon registration. Initial registration of the user may further include additional data entry such as service provider associations, commonly visited locations, friend users, etc.

Upon user registration or any time thereafter, the user may identify one or more “preferred service provider.” A preferred SP (herein also a “PSP”) is a SP that has been identified by the user as suitable/desirable for providing transportation services. Once so identified, an identifier tag (e.g., phone number, PIN, etc.) assigned to the PSP is associated to the user's record, such as by placing such identifier tag in a PSP field of the user's record. The PSP field may contain any number of preferred service providers including different types of service providers such as preferred taxi drivers, preferred couriers, preferred housekeepers, etc. (such types may be held together within the PSP field or may be stored separately so that the system can provide separate types based on the contents of a user request). Identification of a PSP can be carried out from the user interface on the user device (described herein), or from an administrator interface at the server or a terminal networked to the server. Identification of a PSP may involve the user assigning a ranking or a rating to the PSP such that the PSPs in the PSP field can be ordered according to user preference.

Upon user registration or any time thereafter, the user may identify one or more “friend user”. A friend user is another user that has been identified (by the user manually or by the system automatically as described herein) as an acquaintance of the user. Once so identified, an identifier tag (e.g., phone number, PIN, etc.) assigned to the friend user is associated to the user's record, such as by placing such identifier tag in a friend user field of the user's record. Friend users may be automatically obtained via relationships on one or more social media platforms. For example, to establish friend users of a user's FACEBOOK® or LINKEDIN® connections the system cross-references such connection lists (which may be obtained directly by accessing the relevant platform, with or without the user's authentication data where appropriate) with that of all users in the system. In embodiments, for the social media platform TWITTER®, the system identifies and prioritizes mutual follows (i.e., a pair of users where both users “follow” each other), before using one-way follows (i.e., where the user follows another user but the other user does not follow the user).

Application software may be installed on one or more user devices (e.g. mobile or fixed communication devices as mentioned herein) after the user is registered. Such software may require authentication of the user, such as by an application PIN (e.g., a username, number, or the like), prior to allowing access by the user. Certain functionalities of the application software (such as emergency service requests, etc.) may be available to the user even without such authentication. The application software provides a user interface that presents the various options to the user. Details of the user interface are dependent on the platform of the device (i.e., mobile v. fixed, various operating systems, etc.), and further description of the user interface is provided herein throughout.

In embodiments, the user makes a request (via the user interface) for transportation service using a mobile communication device (also referred to as a “mobile device”, e.g., a mobile phone) or via a website on a fixed communication device (e.g., a computer connected to a network). A user making such a request is referred to herein as a “requesting user.” The request is sent via a network and is received by the server for further processing as described herein.

Where a mobile device is used to make the request, such device may transmit the request via any suitable means, such as via SMS, USSD, a data network, peer-to-peer mesh networking, and the like. Where the mobile device uses a data network, such use may be via any suitable interface such as an Internet website (e.g., accessed by an internet browser application), an instant messaging platform (e.g., WhatsApp Messenger), or the like. In embodiments the request is prepared and processed by use of a dedicated application on the mobile device (i.e., software specifically designed and installed on the device to interface with the server described herein).

The request comprises the record indexer, and may further comprise other identification information, such as the requesting user's name, age, email address, mobile number, government-issued ID number, PIN, or the like. The request may further comprise a time and date stamp.

The request further comprises a requested service, which in some embodiments comprises an instruction. Such instruction may be selected by the user from a predetermined list of instructions, or may be customized by the user, or may be a combination of predetermined and user-provided elements. Examples of predetermined instructions may include: “send a taxi to my current location”; “send a courier to my favorite location X” (wherein “X” is a location that may be input upon registration or thereafter by the user); and the like. Examples of combination instructions may include: “send a taxi to the following location” (with subsequent input of the desired location by the user), and the like. The instruction may be a fully customized instruction, with the user inputting the instruction in text format or otherwise. In embodiments, the user interface presents the user with a list of options for creating the instruction (i.e., the user may select to send a predetermined instruction, a fully customized instruction, or a hybrid).

The request may further comprise a location (referred to as the “origin location”), such as the location of the requesting user at the time that the request is sent by the user. Such origin location may be input/provided by the requesting user, or may be automatically determined using any convenient method such as via a Global Positioning System (GPS) module, via Assisted GPS (A-GPS), via the SIM using mobile communication signals received by the mobile device, WiFi sniffing, mobile transmission signal triangulation, or the like. The origin location may be purely coordinate-based, if determined and provided automatically, or may be analog (e.g., referenced to streets, intersections, landmarks, etc.) if provided manually. In embodiments, the origin location may be referenced to a digital mapping service such as GOOGLE® Maps or the like.

The requested service may involve an instruction whereby the user asks for transportation service to be sent to a specified location, where such location is not necessarily the location of the communication device from which the request is sent (e.g., if the user sends an instruction that states “send a taxi to the following location” and subsequently inputs a location different from the user's current location). In such embodiments, the request may optionally also include the location of the communication device, but the server will use the specified location as the origin location. In this way the requesting user can also request transportation services for a third party—e.g., by specifying the location of the third party as the origin location.

The request may further comprise a destination location. The destination location is input by the user (either manually or selected from a list of favorite destinations and/or common destinations) and represents the location to which the user wishes to travel or to have goods taken. As with the origin location, the destination location can be coordinate based or analog, and may be referenced to a digital mapping service.

In embodiments, the user's device (particularly mobile devices) may be configured to automatically generate/transmit a request, such as a predetermined time, or when the device reaches a predetermined location, or just prior to the device powering down (such as due to a dead battery). The user's device may also be configured to generate/transmit a request in response to a single-action entry by the user (e.g., via a dedicated button or field on the device, or via an icon in the user interface), such as for an emergency request or the like. The device may be further configured to require the user to enter various information in order to prepare/transmit the request, such as destination information, an application PIN, etc.

The server, upon receipt of the request from a requesting user, accesses the user record corresponding to the record indexer as provided in the request. Further processing of the request may involve a number of steps depending on the contents of the request, particularly depending on the instruction contained within the request. The server processes the request to determine the instruction and any other information contained within the request (such as origin and destination locations, etc.), and may store the request in the requesting user's record for archival or other purposes.

In embodiments, the server prepares a response to the request, and transmits/delivers the response to the requesting user. Typically the response and the request are transmitted via the same mode of communication (e.g., an SMS request generates an SMS response), although different modes can be used for the two transmissions if desired or appropriate.

In embodiments, the response contains an acknowledgment of receipt of the request. Alternatively, an acknowledgement of receipt can be generated and transmitted to the requesting user separate and apart from the response. The acknowledgment of receipt may contain, for example, contact information for a helpline or other general information (i.e., not specifically related to the request) deemed useful to the requesting user. In embodiments, no acknowledgment of receipt is transmitted to the user, e.g., in order to reduce communication traffic.

In embodiments, the response contains a ranked list of preferred service providers (PSPs). The ranked list of PSPs may contain any number of entries, from 1-20,or more than 20, such as 1-10, or 1-5 entries. The ranked list of PSPs is particularly generated and included in the response where the request contains an instruction that calls for provision of transportation services, such as a taxi pick-up.

Generation of the ranked list of PSPs involves the following steps. The server accesses the preferred SP field in the requesting user's record. One or more (e.g., all, or a selected subset, such as the five with the top rankings, or all PSPs with the highest possible rating) of the PSPs in the preferred SP field are read and added to the ranked list of PSPs—such PSPs in the ranked list of PSPs are referred to as “first PSPs”. In embodiments, the server then accesses the requesting user's set of friend users (e.g., as located in the friend user field of the requesting user's record), and, for one or more such friend user, the server reads one or more PSPs from the PSP field of the friend user record (also referred to herein as “friend user PSP”). The identified friend user PSP may then be added to the ranked list of PSPs. Again, all or a subset of friend user PSPs may be used and added to the ranked list of PSPs, and such friend user PSPs may also be referred to herein as “second PSPs”. Then, in embodiments, for each (or a subset) of the first PSPs that have been added to the ranked list of PSPs, the server accesses ASPs and adds one or more such ASPs to the ranked list of PSPs—these are also referred to herein as “third PSPs”. As mentioned herein, ASPs are other SPs that are associated with a particular SP—these may be co-workers of the particular SPs if the particular SP works for a transportation service company, or may be “favorited” SPs of the particular SP—i.e., other SPs that have been identified upon registration or thereafter by the SP as reliable, trustworthy, effective, and/or otherwise desirable as a SP.

In embodiments, the ranked list of PSPs may be further augmented beyond the first, second, and third PSPs as described. Such augmentation may be, for example, by identification of “fourth PSPs”, which are PSPs identified by “followers” of the requesting user. A follower is a user who is associated with the requesting user via a relationship on a social media platform, such as a follower on TWITTER®, a friend on FACEBOOK®, a contact on LINKEDIN®, or the like. Followers may also be, but are not necessarily, friend users of the requesting user. Such augmentation may also be, for example, by provision of “general PSPs” which are SPs from a global set of SPs within the system (e.g., all SPs registered with the system). Selection of such general PSPs may be influenced by one or more factors associated with each SP—such as user ratings, performance history, and the like.

It will be appreciated that, at least because of the addition of third PSPs and fourth PSPs, a ranked list of PSPs may in fact contain service providers that are not listed as “preferred” with respect to the requesting user.

The ranked list of PSPs may be ordered according to any suitable factor, and in embodiments the ranked list is presented as an ordered list of PSPs. In embodiments, first PSPs will be presented at the top of the list, followed by second PSPs, and so on. Furthermore, within each level (first, second, etc.), the PSPs maybe further ordered according to factors such as user ratings (i.e., a user-entered preference level for the SP, which may be a star rating, a numerical rating, or the like), performance history, frequency of use by the requesting user, etc.

A further factor that can be used for ordering the ranked list of PSPs (either within a level or across levels, or both) is proximity to the requesting user. As mentioned herein, the request sent by the requesting user may comprise an origin location of the requesting user. Proximity therefore requires knowledge of the location of a SP, and may further require knowledge of vehicle-accessible routes between the origin location and the SP's location. Such vehicle-accessible routes may be stored internally on the server or may be obtained from any third-party mapping platform such as GOOGLE® Maps. Furthermore, such proximity factor can take into account traffic patterns, road conditions, weather, or other such environmental factors as appropriate. Proximity can be measured/reported as a function of time (i.e., the estimated amount of time it would take the SP to cover the distance between the SP's location and the origin location), or as a function of distance, or both. In embodiments, the location of the SP is measured periodically (e.g., every minute, or every 5 minutes, etc.) and automatically by the SP Device, and is communicated to the server. The server receives the location and stores it in the SP's record. In other embodiments the SP's location is determined only when the SP appears on a ranked list of PSPs. Such determination requires that the server request and then receive an instantaneous location from the SP Device.

A further factor that can be used for ordering the ranked list of PSPs into a list is a SP performance rating, which performance rating is based on performance data. Performance data may include customer ratings, sensor-collected data on driving habits, (e.g., an accelerometer on the SP Device, etc.), an acceptance rate (i.e., what % of rides that we send to the driver does he complete, what percent does he complete), or the like.

Ordering of the ranked list of PSPs can also be accomplished with an algorithm that gives weight to a plurality of factors (also referred to herein as a “combination factor”)—with some factors (such as, for example, proximity to the requesting user) receiving more weight and other factors (such as, for example, frequency of use by the user) receiving less weight. The resulting weighted factors can be combined to provide a composite score that is used to rank the PSPs. The weight of each factor can be predetermined or can be provided by the requesting user. The factors can be used within each level separately (i.e., within each group of first PSPs, and separately within each group of second PSPs, etc.), or can be used collectively across levels.

A factor that may be part of the combination factor used to rank the entries in the list of PSPs is determined from a Social Graph Database (SGD). The SGD is modeled using a graph database, where registered clients/users and service providers are modeled as nodes, and their social relationships are modeled as relations of different types and kinds between nodes. For example, client node A might be related to client node B via a bi-directional relation of type “social” and kind “Facebook” and a uni-directional relation of type “social” and kind “Twitter Follower”. A client node might further be related to a service provider node via a uni-directional relation of type “favourite”, and driver nodes may be related to one another with relations of type “colleague”. A social distance between a client node C and a service provider node SP is then defined as a pair (length, quality), where length is the length of the shortest path between C and SP such that quality is maximised. Quality is determined by an aggregation of the relation types and kinds on that path. For example, the quality might be determined using a minimax strategy over a pre-defined hierarchy of social relationship kinds: for any set of relations between two nodes, only the “best” one is considered, but for the overall path, the “worst” of these “best” relationship determines the quality of the whole path. If C and SP have multiple different social distances, they can be ordered by using some factor to trade off length vs. quality.

Therefore, for example, the server can query the SGD to retrieve all paths between C and SP (possibly bounding by length), determine the minimum social distance, and then use this to determine the user's expected preference of this SP compared to other SPs.

The relations in the SGD are built, e.g., by: 1. querying social network APIs to which users give access (e.g. on sign up or on login); 2. evaluating users' contacts in their phonebooks on their devices by creating relations for those contacts who are also users or service providers already, and offering to refer the service to such contacts otherwise; 3. tracking users' or service providers' referrals to the application to other potential users or service providers (made from a homepage, application, or manually); and 4. users making service providers their favourites by using the application described herein.

Relational data obtained from the SGD can be used as a factor in the combination factor, and the combination factor is used to rank SPs in creating the ranked list of PSPs. The SGD will require updating based on a number of actions, such as where a user changes the status of a PSP associated with that user.

Once the ranked list of PSPs has been prepared, the server transmits the ranked list of PSPs (or selected data from the ranked list) to the requesting user as part of the response. The ranked list of PSPs may be formatted in any convenient manner, such as in a ordered list (with the ordering as described herein), or as a structured presentation (e.g., by grouping first PSPs into a visual conglomerate, the second PSPs into a second visual conglomerate, etc.). Each entry in the list may provide one or more identifiers of the PSP (e.g., a name, phone number, vehicle number, email address, SPPIN, etc.), and may further contain additional information for display on the requesting user's device, such addition information including one or more of: contact data (e.g., phone number, etc.); location data (e.g., the PSP's current location; or the PSP's proximity either in time or in distance, or both, as described above); performance data (e.g., preference level as reported by the user, acceptance rate, driving history, etc.); relational data (i.e., information about how the PSP is connected with the requesting user, such as the chain of direct or indirect relationships in social media or another such medium), and the like.

In addition to transmitting the ranked list of PSPs to the requesting user, the server may optionally also notify all or a subset of the SPs in the ranked list of PSPs that such service has been requested, and that their details have been transmitted to the requesting user. Such notification of the SPs is helpful so that they can be aware of a possible pending job.

Once the user receives the response from the server, the user may elect to act or not to act based on the received information. In embodiments, the user can directly contact one of the PSPs provided in the ranked list of PSPs in the response. Alternatively, the user can respond to the server with a decision (e.g., a section of one of the service providers), and the server can be configured to forward the user decision to the selected SP.

### Hardware

The method involves a server on a network. The server may be standalone or may involve cloud storage and cloud computing. The network is, for example, the Internet, or any suitable network for interconnecting the devices described herein. The server contains machine readable instructions for executing the processes described herein.

As mentioned, the user uses a communication device that may be a mobile device such as a mobile phone or a fixed device such as a networked computer. The device may have an installed application (i.e., a dedicated program on a computer readable medium containing computer instructions to carry out the methods described), and if the device does not have an installed application then the user may use a standard feature of the device such as SMS service or the like.

As mentioned, the SP uses a mobile communication device. The device comprises a GPS or other location-determining module and further comprises an application and interface that allow the SP to interact with the server, receive transportation requests, notify the system of availability (or non-availability), and the like. The device may have an installed application (i.e., a dedicated program on a computer readable medium containing computer instructions to carry out the methods described), and if the device does not have an installed application then the SP may use a standard feature of the device such as SMS service or the like.

The aspects and embodiments described herein are suitable for enabling a user to locate and engage a service provider. The service performed by the service provider may be any suitable service, with some non-limiting examples including: transportation (e.g., taxi service, courier service, moving and freight service, and the like); professional services (e.g., accountancy, legal, handyman, housekeeping, and the like); and personal services (e.g., errands and messenger services, and the like). Throughout this application and merely for the sake of convenience transportation requests are used to help explain the inventive methods and systems; the invention is not intended to be limited by such explanations.

### Process

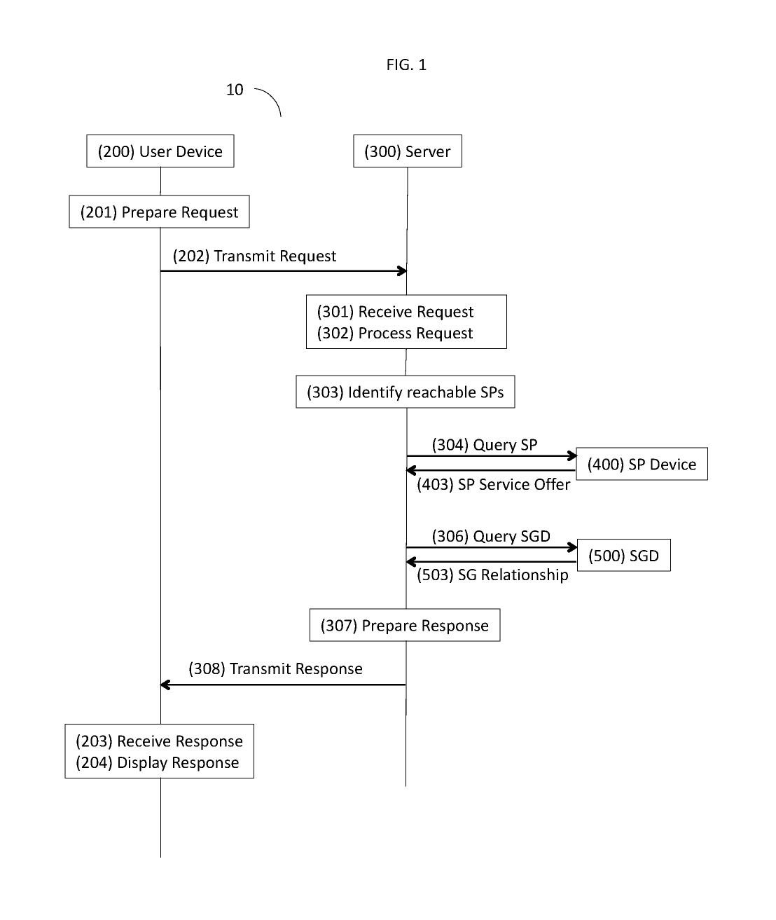

FIGS. 1-3 show an example embodiment of the system and methods disclosed herein, and are used to help illustrate the invention.

With reference to FIG. 1, system and process 10 is shown, containing a User Device 200 (e.g., a mobile phone), Server 300, SP Device 400 (e.g., a mobile phone), and Social Graph Database (SGD) 500. A user (not shown) prepares a request (201) by inputting data and/or instructions into User Device 200. The User Device then transmits the request (202) over a network to Server 300, which receives the request (301). The user device then awaits service offers from the server (203) until a timeout is reached. The Server 300 processes the request (302), e.g. it verifies its validity, stores it in a database, etc. Server 300 then identifies SPs who potentially might serve the request (303)—i.e., identifies those SPs who are reachable given the requesting user's location. To the devices of reachable SPs, Server 300 transmits a query (304) that requests the availability of the SP. Such SP query may be sent out to zero SPs (i.e., if no SPs are in the vicinity of the requesting user), or to any number of SPs depending on the relative positions of the SPs. The server then awaits service offers from SPs until a timeout is reached. Every SP device receiving the query (401) then evaluates the request—this may happen e.g. by displaying the request and awaiting user input, or automatically. If the SP Device is to offer the requested service, it sends a Service Offer back to the server (403). For each such received Service Offer, the server requests (306) the social relationships between the requesting user and the offering SP from the social graph database (SGD) (500), where a social relationship is a sequence of social links such as favourite SP, phonebook contact, FACEBOOK® friend, TWITTER® follower etc. which is stored in the social graph database. The length of such sequences may be bounded by a maximum set by the server. The SGD (500) receives this request (306) and executes an according query against its internal graph data model. The SGD (500) then sends the retrieved social relationships back to the server (503). Server (300) then sorts the set of offering SPs according to the social distance (307). The social distance is determined by comparing the path lengths and link types (e.g. phonebook contact, Facebook™ friend) of social relationships to one another. Possibly also other criteria are considered such as expected service execution time or quality to break ties. The resulting order is assumed to predict the requesting user's order of preference of offering SPs. The resulting order is used to create the ranked list of preferred service providers, and is used to prepare a response (307) based on the ranked list. Server (300) therefore sends the ordered offer ranked list back to the user device (308). User device (200) then receives the response (203) and evaluates the offers (204)—e.g. by displaying them to the user and let them choose, or automatically choosing the first and therefore presumably best option.

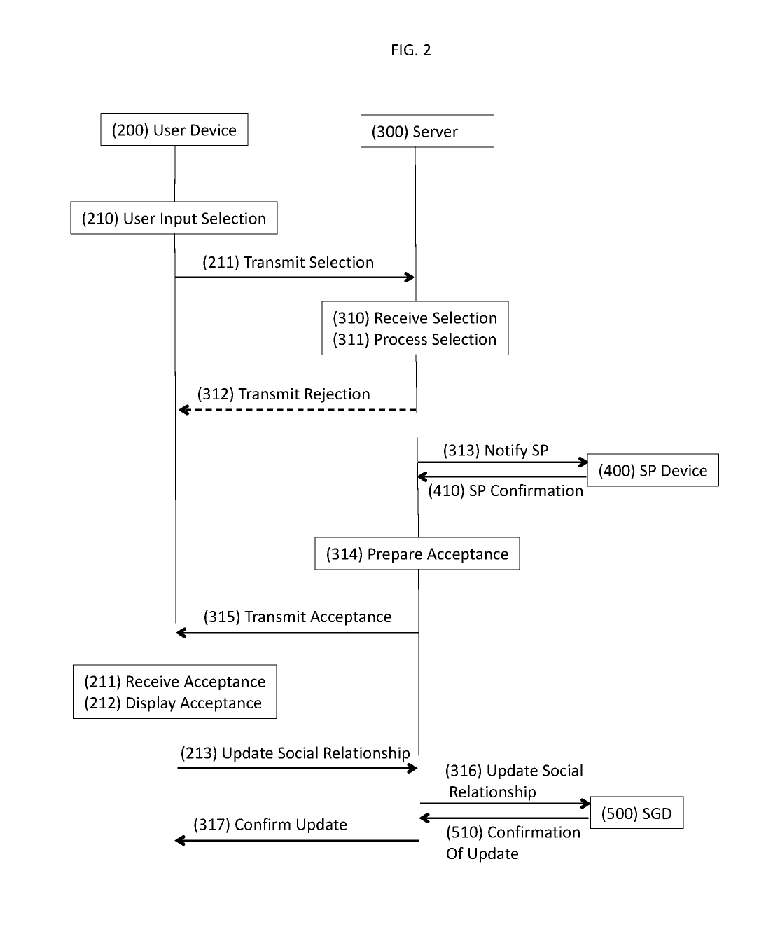

Referring now to FIG. 2, which continues the process described in FIG. 1, provided that a timeout (see 203 in FIG. 1) is not yet reached, user device 200 may await further offer ranked list updates. If a selection is made (either by user input or automatic selection), user device 200 transmits (211) the selection to the server to accept the respective SP's offer. The server, upon receiving this selection (310) then processes the selection (311), which may for example involve identifying all SPs which had offered the service and determines whether the chosen offer is still valid, i.e. had not been cancelled. If the SP has cancelled the offer, user device is informed accordingly (312) which the updates its ranked list of offers accordingly and newly evaluates the updated offer ranked list, likely continuing with a new choice (going back to 210). Otherwise, if the chosen offer is still valid, it is marked as accepted by the server. The server then informs the SP whose offer was accepted and the SP(s) whose offers were not chosen that their offers are now cancelled (313). Each such SP receives the acceptance or cancellation and updates its application state accordingly, e.g. by updating a display of active offers. For the non-accepted offers, the SP Device then confirms the cancellation back to the server (410). For the accepted offer, the respective SP device receives the acceptance (313) and updates its application state accordingly e.g. by displaying detailed information about the requested service. It then confirms the acceptance back to the server (410). The server then prepares an acceptance notice (314) and confirms the choice of offer back to the user device (315), which receives the acceptance (211), displays the acceptance (212), and updates its application state accordingly in turn.

Still referring to FIG. 2, sometime after the service execution, the user device may send an update (213) of the user's social relationship with the SP who sent the chosen offer to the server—e.g. the SP becomes a favourite of the user. The server, upon receiving such an update, processes the update (not shown) and sends a corresponding update message to the social graph database (316), which updated its internal data model accordingly and confirms this update back to the server (510). The server in turn confirms the update back to the user device (317).

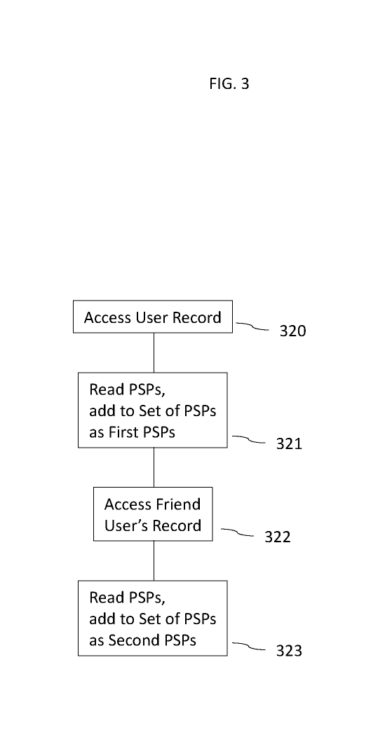

In an alternative embodiment shown in FIG. 3, steps for a Server (not labeled) to process a request (also not labeled) are shown. The Server accesses a user record (320) corresponding to the user responsible for submitted a request. The user record may contain a list of PSP, and the Server reads such PSPs and adds them (in whole or in part) to a set of PSPs, optionally identifying them as first PSPs within the set of PSPs. The user record may further contain an identification of a fried user, and the Server then accesses the friend user's record (322). From the friend user record the Server reads PSPs and adds them (in whole or in part) to the set of PSPs, optionally identifying them as second PSPs within the set of PSPs. The set of PSPs is then ready to be used in a response to the user, as shown in FIG. 1. The set may be ordered into a ranked list of PSPs using a combination factor as described herein. Alternatively, additional PSPs can be added to the set of PSPs (e.g., via association with the PSP already in the set of PSPs or from a global list) prior to using the set of PSPs in preparing the response.

It is to be understood that while the invention has been described in conjunction with examples of specific embodiments thereof, that the foregoing description is intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. Furthermore, all possible combinations of the various features and steps are intended to be part of the invention as if they were laboriously disclosed in this application.

What is claimed is:

1. A method comprising:
receiving, by a server over a network, a request from a requesting user, the request comprising a requested service, and an identification of the requesting user;
in response to the request, determining a ranked list of preferred service providers by:
(a) accessing, on the server, data for a first preferred service provider associated with the requesting user, wherein the data comprises identification data and location data;
(b) accessing, on the server, data for a second preferred service provider associated with a friend user, wherein the friend user is associated with the requesting user on a social network and wherein the data comprises identification data and location data;
(c) assigning, using a combination factor, a ranking to the first preferred service provider and a ranking to the second preferred service provider, and creating the ranked list of preferred service providers from the assigned rankings; and
transmitting data from the ranked list of preferred service providers to the requesting user via the network.

2. The method of claim 1, wherein the ranked list of preferred service providers comprises a plurality of preferred service providers associated with the requesting user, and a plurality of preferred service providers associated with the friend user.

3. The method of claim 1, wherein the combination factor includes one or more factors selected from: instantaneous preferred service provider proximity to the requesting user; social relation of the preferred service provider to the requesting user; historical performance of the preferred service provider; preference level of the requesting user;
and preference level of the friend user.

4. The method of claim 1, wherein the ranked list of preferred service providers comprises a plurality of preferred service providers associated with the requesting user, and a plurality of preferred service providers associated with the friend user; and wherein the combination factor includes one or more factors selected from: instantaneous preferred service provider proximity to the requesting user; social relation of the preferred service provider to the requesting user; historical performance of the preferred service provider; preference level of the requesting user; and preference level of the friend user.

5. The method of claim 1, wherein:
the data accessed for the first preferred service provider further includes data selected from performance data; relational data; and preference level of the requesting user; and
the data accessed for the second preferred service provider further includes data selected from performance data; relational data; and preference level of the friend user.

6. The method of claim 1, wherein the request further comprises an origin location and a destination location, and where in the request is for a transportation service.

7. The method of claim 1, wherein the request is received via SMS, USSD, a data network, or peer-to-peer mesh networking.

8. The method of claim 1, wherein:
the ranked list of preferred service providers comprises a plurality of preferred service providers associated with the requesting user, and a plurality of preferred service providers associated with the friend user; and
the ranked list of preferred service providers further comprises a service providers from a global list of service providers.

9. The method of claim 1, wherein the transmitted data is received by the requesting user, and wherein the method further comprises receiving, by the server over the network, a selection from the requesting user.

10. The method of claim 1, further comprising retrieving, from the server, identification data and location data for a third preferred service provider, wherein the third preferred service provider is associated with the first preferred service provider.

11. The method of claim 1, further comprising determining a follower user associated with the requesting user on a social network, and retrieving from the server identification data and location data for a fourth preferred service provider, wherein the fourth preferred service provider is associated with the follower user.

12. The method of claim 1, wherein the method further comprises transmitting, by the server: a service request to the first preferred service provider; and a service request to the second preferred service provider.

13. The method of claim 1, wherein the method further comprises:
transmitting, by the server, a service request to the first preferred service provider, and a service request to the second preferred service provider; and
receiving, by the server, a response from the first preferred service provider, the response selected from an acceptance of the service request or a rejection of the service request.

14. The method of claim 1, wherein the method further comprises receiving, by the server, a selection from the requesting user, wherein the selection identifies one preferred service provider in the ranked list of preferred service providers.

15. The method of claim 1, wherein the method further comprises:
receiving, by the server, a selection from the requesting user, wherein the selection identifies one preferred service provider in the ranked list of preferred service providers; and
transmitting, by the server, an acceptance to the identified preferred service provider.
